(19) United States
(12) Patent Application Publication
(10) Pub. No.: US 2014/0244600 A1
(43) Pub. Date: Aug. 28, 2014

(54) MANAGING DUPLICATE MEDIA ITEMS

(71) Applicant: APPLE INC, Cupertino, CA (US)

(72) Inventors: Edward Thomas Schmidt, Burlingame, CA (US); Nicholas James Paulson, San Francisco, CA (US)

(73) Assignee: Apple Inc, Cupertino, CA (US)

(21) Appl. No.: 13/775,439

(22) Filed: Feb. 25, 2013

(51) Int. Cl. G06F 17/30

(52) U.S. Cl. CPC G06F 17/30156
USPC 707/692

(57) ABSTRACT

Systems, methods, devices, and computer-readable media for managing duplicate media items. The system first analyzes a first file from a first source, wherein the first file is a duplicate of a second file. Next, the system deduplicates the first file and the second file to yield a deduplicated file. The system then selects metadata associated with at least one of the first file or the second file to be assigned as metadata for the deduplicated file, the metadata being selected based on a priority preference.

### TECHNICAL FIELD

The present technology pertains to media content, and more specifically pertains to managing duplicate media items and metadata associated with the duplicate media items.

### BACKGROUND

Media playback capabilities have been integrated with remarkable regularity in a score of common, everyday devices such as mobile phones and portable players. Not surprisingly, the widespread availability of media-capable devices has prompted an enormous demand for digital media. In turn, the Internet has served as a popular resource for digital media, greatly expanding the amount of digital media available to users and providing an ever widening audience for conveniently sharing and downloading digital media. Numerous media applications, both local applications and online applications, have emerged to allow users to share, access, download, organize, and manipulate media items. Users often maintain a large number of media items in multiple media applications and devices. Many times, a single media application used by a user can maintain media items shared or downloaded from different devices and different sources, such as other media applications.

Typically, a media application maintains a database of media items available for use by the user through the media application. In addition, the database of media items generally includes metadata associated with each media item. The metadata can provide useful information about the media item to the user. Users can add media items and metadata to the database in a number of ways, such as synchronizing content from another application or device, purchasing and downloading media items from an online store, downloading media items from the Internet, etc. The metadata associated with the media items typically varies based on the source of the media item and metadata. For example, a media item synchronized from a particular online media store can have a vast amount of metadata, including user personalized metadata, while a media item associated with a different online media store can have a different set of metadata, and perhaps include less metadata.

Given the numerous sources of media items and metadata, users often share duplicate items between media applications and devices. However, because media items from different sources can have different sets of metadata, it is difficult to determine which portions of metadata from the different sets of metadata should be maintained in the media application's database of media items. Generally, when a media application receives a new media item that is a duplicate of an existing media item, the media application simply overwrites the existing metadata with the metadata from the new media item or does no deduplication at all, and presents two separate copies of the item to the user. Unfortunately, with this approach, the user often loses important metadata.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, devices, and non-transitory computer-readable storage media for managing duplicate media items. The system can analyze a first file from a first source to determine that the first file is a duplicate of a second file. The system can determine if the files are the same by comparing any of the various characteristics and/or attributes of the files, as well as any information, metadata, and/or content associated with the files. For example, the system can compare any identifiers associated with the files, such as store identifiers, a title of the files, a size of the files, a source of the files, a playback length of the files, the type of files, a date of the files, an author of the files, a property of the files, etc. The system can also make a determination that the files are the same based on a similarity threshold, for example.

Next, the system can deduplicate the first file and the second file to yield a deduplicated file. Since the first file is a duplicate of the second file, the system can deduplicate the files to select a single instance of the files for storage and/or use, rather than maintain two copies of the same file. Here, deduplication can refer to the process of reducing two or more duplicate files to a single version of the file, such as selecting a duplicate file to maintain and ignoring any other duplicates of that file or combining portions of multiple duplicate files to yield a single file. By removing duplicate copies of files, the deduplication process can reduce the storage requirements and facilitate the management of files. The system can deduplicate the first file and the second file by removing or ignoring one of the duplicate files. The system can select to keep one of the duplicate files and remove or ignore the other duplicate file based on a preference, a predicate, a priority, etc. For example, the system can select the file to keep according to a priority, which can be based, for example, on an age of the duplicate files, a source of the duplicate files, a quality of the duplicate files, a request from a user, a preference, etc.

The system then selects metadata associated with at least one of the first file or the second file to be assigned as metadata for the deduplicated file, the metadata being selected based on a priority preference. The selected metadata can be associated with the deduplicated file, as belonging to the deduplicated file. The selected metadata can also be stored in a database and associated with the deduplicated file. Moreover, the selected metadata can be integrated into the deduplicated file as part of the file. The selected metadata can include a portion of the metadata of the first file and a portion of the metadata of the second file. For example, the selected metadata can be a combination of metadata from the first file and the second file. The selected metadata can also include all of the metadata of the first file and/or all of the metadata of the second file. In selecting the metadata, the system can ignore null values of metadata and/or avoid selecting duplicate values of metadata, such that the selected metadata does not contain any null and/or duplicate values.

As previously mentioned, the metadata can be selected based on a priority preference. The priority preference can be based on one or more rules implemented for selecting, ranking, ordering, ignoring, preserving, and/or overwriting metadata. Moreover, the one or more rules can be based on various characteristics/attributes associated with the metadata, such as a metadata type, a metadata source, a metadata quality, a metadata value, a metadata property, an associated media item, an associated application, existing metadata, a flag, a parameter, etc. The one or more rules can define how the various characteristics/attributes associated with the metadata are ranked, weighed, calculated, related, compared, analyzed, interpreted, etc. For example, the one or more rules can specify weights and/or degrees of importance assigned to different metadata types. To illustrate, metadata identified as “system” metadata, such as metadata that is part of the source code and/or metadata that is used by the operating system to execute operations, can be classified as important, whereas synchronization metadata can be classified as less important. As another example, the one or more rules can specify ranks and/or weights assigned to different sources of metadata. Here, the one or more rules can assign a higher ranking to one source, such as an online media store like Apple® iTunes® Store, which can be a trusted online store and/or an online store known to have good metadata, over another source, such as the Internet. For example, metadata inputted by a user can be ranked higher than metadata downloaded from the Internet.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example configuration for managing duplicate media items;

FIG. 2 illustrates an example system for managing duplicate media items;

FIG. 3 illustrates an example flowchart for managing duplicate media items;

FIG. 4 illustrates an example method embodiment;

FIG. 5 illustrates an example source-to-rules matrix;

FIG. 6A illustrates an example system embodiment; and

FIG. 6B illustrates another example system embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

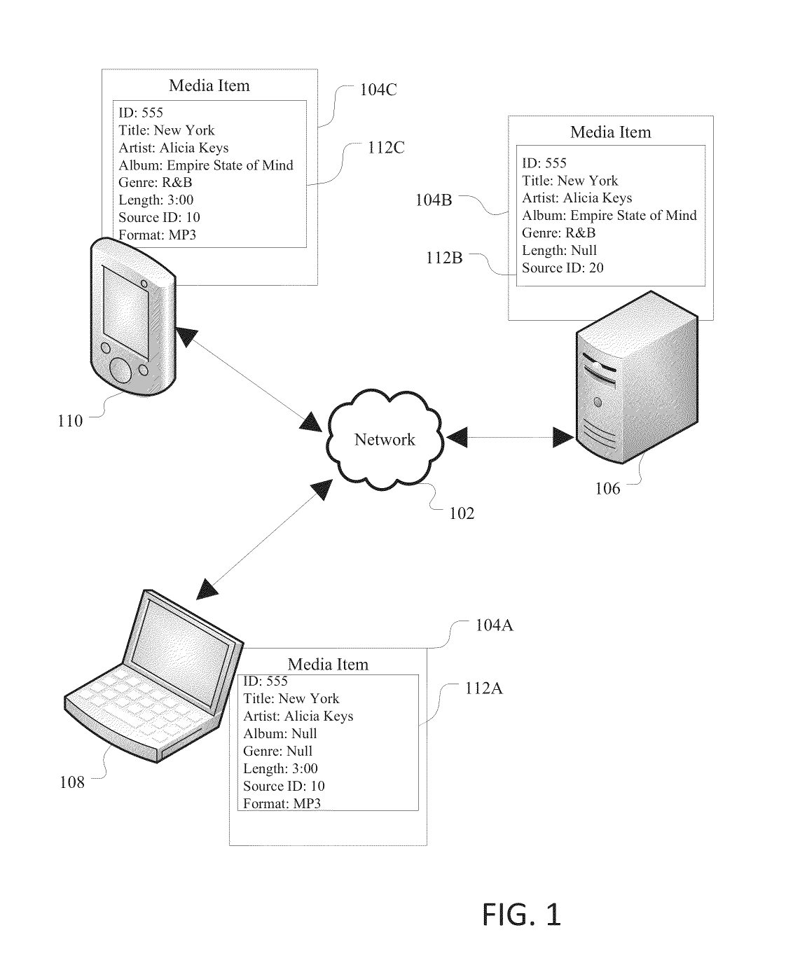

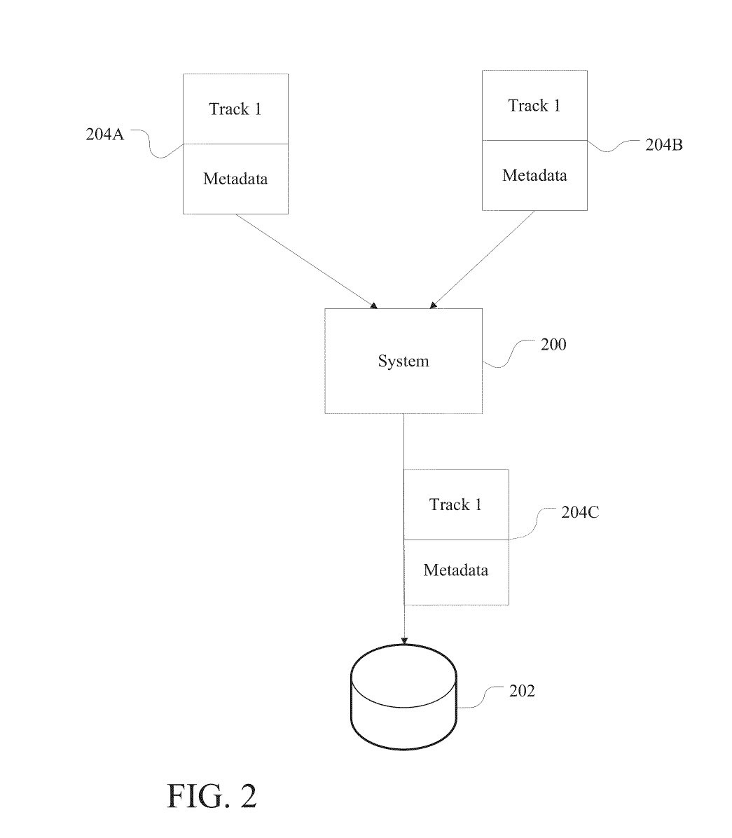

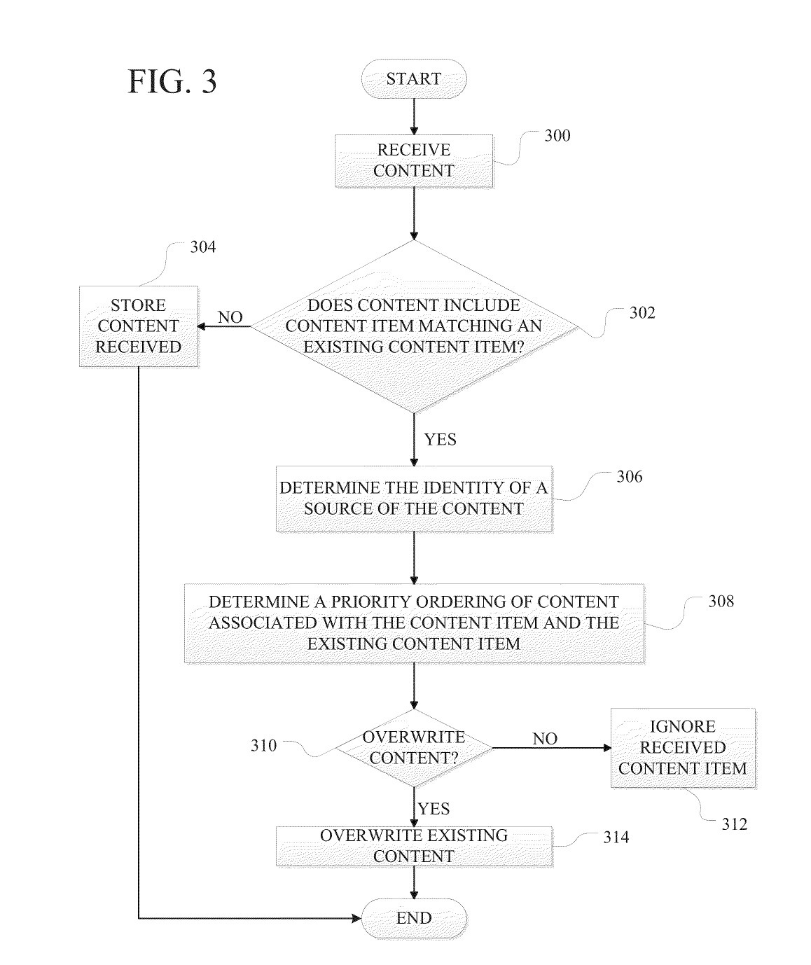

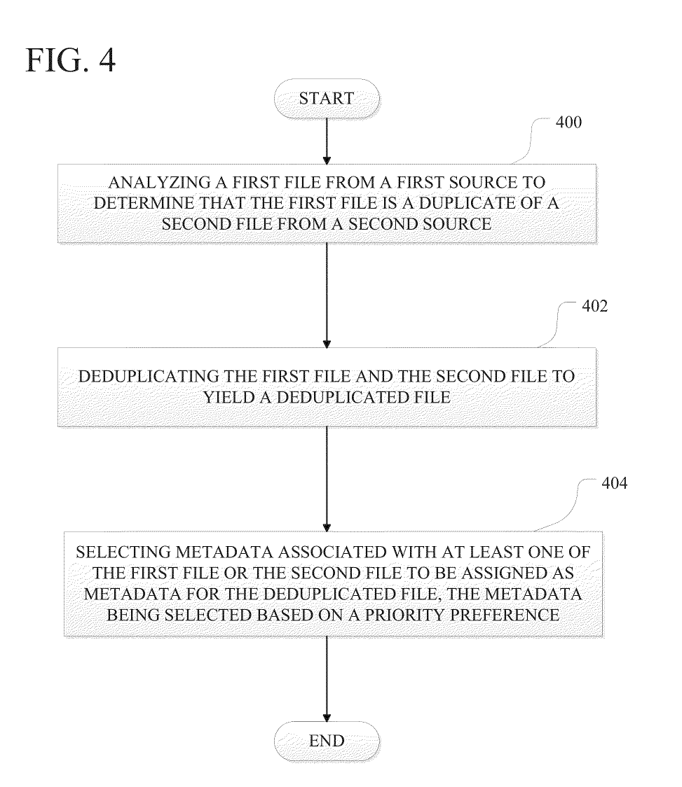

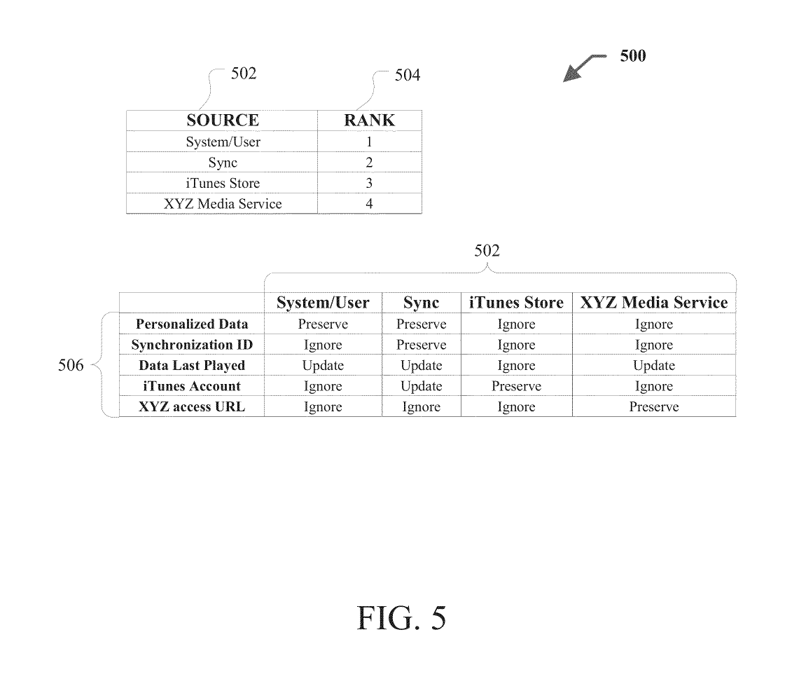

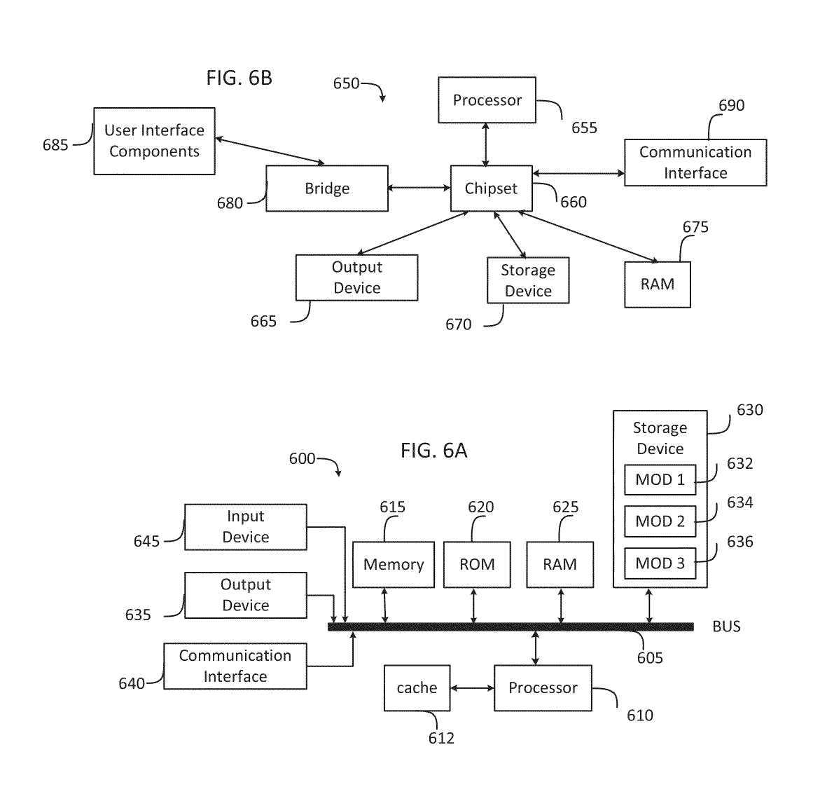

The disclosed technology addresses the need in the art for efficiently and effectively managing duplicate media items. A system, method, device, and computer-readable media are disclosed for managing duplicate media items, including metadata. A description and variations of an exemplary configuration for managing duplicate media items, as illustrated in FIGS. 1 and 2, and a flowchart and method for managing duplicate media items, as illustrated in FIGS. 3 and 4, is disclosed herein. An example of a source-to-rules matrix in FIG. 5, and a description of a basic general purpose system or computing device in FIGS. 6A and 6B, which can be employed to practice the concepts, will then follow. These variations shall be described herein as the various embodiments are set forth. The disclosure now turns to FIG. 1.

FIG. 1 illustrates an example configuration for managing duplicate media items. Here, the cloud resource 106 and user devices 108, 110 can communicate media content with each other, and each can store media content for access by a user. For example, the cloud resource 106 and user devices 108, 110 can synchronize media content with each other to maintain a consistent library of media content. The user devices 108, 110 can analyze the content they receive from the cloud resource 106, a user and/or any other device to determine if the content includes any duplicate media items. Further, the user devices 108, 110 can analyze the received content and determine if any media item in the content is a duplicate (i.e., is the same or substantially the same) of an existing media item (e.g., a previously stored and/or received media item). This way, the cloud resource 106 and user devices 108, 110 can identify and manage any duplicate media items.

For example, the cloud resource 106 can send media item 104B to the user device 110 via network 102. The media item 104B can include, for example, metadata 112B and media content, such as video, audio, text, images, etc. The user device 108 can also send the media item 104A to user device 110. The user device 110 can receive the media item 104A, analyze it, and compare it with the media item 104B stored at the user device 110, to determine if the media item 104B is a duplicate of the media item 104A. If the media item 104B is a duplicate of media item 104A, the user device 110 can determine whether to preserve the media item 104A and ignore the media item 104B, or overwrite the media item 104A with the media item 104B. The user device 110 can also determine whether to preserve some or all of the metadata 112A associated with the media item 104A and ignore some or all of the metadata 112B associated with the media item 104B, or overwrite some or all of the metadata 112A associated with the media item 104A with some or all of the metadata 112B associated with the media item 104B. If user device 110 chooses to keep some metadata from the media item 104A and some metadata from the media item 104B, the device 110 can then create a merged media item, media item 104C.

The user device 110 can determine whether to preserve, overwrite, and/or ignore information based on rules, predicates, and/or priority preferences, as further detailed below in FIGS. 2-4. For example, if the metadata 112B in the media item 104B includes the identifier “555,” and the user device 110 determines that the metadata 112A in the media item 104A already has the identifier “555,” the user device 110 can ignore the identifier “555” from the metadata 112B in the media item 104B. On the other hand, if the metadata 112B in the media item 104B includes a genre value (“R&B”), and the user device 110 determines that the metadata 112A in the media item 104A does not contain a genre value, the user device 110 can add the genre value from the metadata 112B in the media item 104B to the metadata 112A in the media item 104A. Moreover, if the metadata 112B does not include a value corresponding to a metadata field in the metadata 112A, the user device 110 can simply ignore that metadata field. For example, if the metadata 112A contains a length value (“3:00”), but the metadata 112B does not contain a length value, the user device 110 can simply ignore the length field when it receives the metadata 112B. In some embodiments, the priority preferences can specify which metadata fields or portions should be ignored for specific sources. For example, the priority preferences can specify that a specific source does not use a store identifier and, therefore, a store identifier field should be ignored when receiving content from that source.

The cloud resource 106 can communicate with the user devices 108, 110 via network 102. The user devices 108, 110 can communicate with each other via network 102, and/or a direct connection, such as a universal serial bus (USB) connection, a Bluetooth connection, a WIFI Direct connection, etc. The network 102 can include a public network, such as the Internet, but can also include a private or quasi-private network, such as an intranet, a home network, a virtual private network (VPN), a shared collaboration network between separate entities, etc. Indeed, the principles set forth herein can be applied to many types of networks, such as local area networks (LANs), virtual LANs (VLANs), corporate networks, wide area networks, and virtually any other form of network. The user devices 108, 110 can include any media device, such as a laptop computer, a smartphone, a tablet computer, a media player, a game system, a smart television, etc. The cloud resource 106 can include any cloud-based device and/or resource. Moreover, the cloud resource 106 can include a variety of hardware and/or software resources, such as a cloud server, a cloud database, a cloud storage, cloud network, a cloud application, a cloud platform, a cloud computer, a cloud device, and/or any other cloud-based resources.

While FIG. 1 illustrates a network and a cloud resource, one of ordinary skill in the art will readily recognize that the concepts disclosed herein can be implemented in other configurations which may not include a network and/or a cloud resource. For example, the concepts disclosed herein can be applied to a device that is directly connected to another device through a wire and/or a wireless connection. However, the exemplary configuration in FIG. 1 includes a network and cloud resource for illustration purposes.

FIG. 2 illustrates an example system 200 for managing duplicate media items. The system 200 can identify duplicate media content, and deduplicate the media content to maintain a single instance of two or more duplicate items. For example, the system 200 can compare the media item 204A with the media item 204B to determine if they are duplicates. The system 200 can determine that two or more items are duplicates if they are the same. However, in some embodiments, the system 200 can determine that two or more items are duplicates even if they are not exactly the same. For example, the system 200 can determine that two or more items are duplicates if they are substantially the same and/or if they satisfy a similarity threshold.

In FIG. 2, the media item 204A includes a song, Track 1, and metadata associated with the media item 204A; and the media item 204B includes the same song, Track 1, and metadata associated with the media item 204B. Here, the system 200 can compare the media items 204A-B and determine that they represent the same song, Track 1, and are therefore duplicates of each other. Accordingly, the system 200 can deduplicate the media items 204A-B to yield deduplicated media item 204C, which the system 200 can maintain at storage 202. The deduplicated media item 204C can include the song from the media items 204A-B, Track 1, and metadata associated with media item 204A and/or media item 204B. When deduplicating the media items 204A-B to yield the deduplicated media item 204C, the system 200 can preserve the song from media item 204A and ignore the song from media item 204B, or ignore the song from media item 204A and preserve the song from media item 204B. The system 200 can also preserve some or all of the metadata from the media item 204A and ignore some or all of the metadata from the media item 204B, or vice versa. Thus, the system 200 can select content from the media item 204A and/or the media item 204B to maintain as part of the deduplicated media item 204C. Here, the system 200 can select what content (i.e., media items and/or metadata) to preserve or ignore based on priority preferences.

A priority preference can be based on one or more rules implemented for selecting, ranking, ordering, ignoring, preserving, and/or overwriting duplicate content. The one or more rules can be based on various characteristics of the content, such as the type of content, the identity of the source of the content, the quality of the content, the actual content, a property of the content, a relationship of the content to other content, a flag, a parameter, etc. The one or more rules can define how the various characteristics of the content are ranked, weighed, calculated, related, compared, analyzed, interpreted, etc. For example, the one or more rules can define weights assigned to an item based on the age of the item, the source of the item, the quality of the item, etc. The one or more rules can also specify conditions based on actual content. For example, the one or more rules can tell the system 200 to ignore null values of content and/or avoid selecting duplicate values of content, such that the media item 204C does not contain any null and/or duplicate values.

Moreover, the one or more rules can specify weights and/or degrees of importance assigned to different types of content, such as different types of metadata, different content formats, etc. For example, metadata created directly on the device itself can be classified as important because such metadata can be more likely to be correct and/or necessary, whereas synchronization metadata from another source can be classified as less important, as such metadata can be more likely to be inaccurate and/or unnecessary. Moreover, the one or more rules can specify ranks and/or weights assigned to different sources of content. Here, the one or more rules can assign a higher ranking to one source, such as a media application like Apple® iTunes®, over another source, such as the Internet. The one or more rules can also assign a high ranking to personalized metadata (i.e., metadata edited/entered by a user), as such metadata is more likely to be correct and/or desired by the user. In some embodiments, the one or more rules can assign a ranking of metadata in the following order: system metadata can be ranked as the most important, synchronization metadata can be ranked next, metadata from purchases made over the air can be next, metadata from a personalized media service such as Apple® iTunes® Match® can be next, and metadata from an iTunes Store® purchase or a different media service can be ranked as least important.

FIG. 3 illustrates an example flowchart for managing duplicate media items. For the sake of clarity, the flowchart is described in terms of an example system, such as system 650 shown in FIG. 6B below, configured to perform the steps. The steps outlined herein are illustrative and can be implemented in any combination thereof, including combinations that exclude, add, or modify certain steps.

At step 300, the system receives content. The content can include metadata, software, a playlist, a file, and/or media content, such as audio, video, images, text, multimedia, etc. For example, the system can receive a song and metadata about the song. At step 302, the system determines if the content includes a content item matching an existing content item. The existing content item can be a content item stored in the system and/or a content database. The system can determine if a content item matches an existing content item by comparing any of the various characteristics and/or attributes of the content items, as well as any information, metadata, and/or content associated with the content items. For example, the system can compare any attributes associated with the content items, such as store identifiers, a title of the files, a size of the files, a source of the files, a playback length of the files, the type of files, a date of the files, an author of the files, a property of the files, etc. The system can determine if the content item matches an existing content item to identify whether the content item is a duplicate of an existing item or not. The content item can be identified as a duplicate of an existing item if it is the same as the existing item and/or within a similarity threshold and/or probability.

At step 304, if the content does not include a content item matching an existing content item, the system stores the content received. For example, the system can add the content to a content database associated with a media application, such as Apple® iTunes®. On the other hand, if the content does include a content item matching an existing content item, at step 306, the system determines the identity of a source of the content. For example, if the content was received from a media application such as Apple® iTunes®, the system can identify the particular media application as the source of the content. The system can also determine the identity of the source of the existing content. For example, if the existing content item was originally received from an online media service, the system can identify the particular online media service as the source of the existing content item. The system can also identify multiple sources as the sources of the existing content item and/or the received content item. Here, each source can be associated with a different portion of content. Moreover, if the existing content item was received from a first source but a portion of its metadata is modified by a second source, the system can identify or associate the second source as the source of the modified metadata, while leaving the first source as the source of the rest of the metadata. For example, if a user modifies metadata in a content item, the system can identify or associate the user as the source of the modified metadata.

At step 408, the system can determine a priority ordering of content associated with the content item and the existing content item. For example, the system can determine a priority ordering of metadata associated with the content item and the existing content item. The priority ordering can be based on the identity of the source of the content. Here, different sources can be assigned different scores, weights, ranks, importance, etc. For example, the system can assign a higher ranking to one source, such as Apple® iTunes®, over another source, such as the Internet. The identity of the source of the content can then be compared with the identity of the source of the existing content item to determine a priority based on source identities. The priority ordering can also be based on the type of content. For example, different metadata types can be associated with different weights, scores, and/or degrees of importance. To illustrate, metadata identified as “system” metadata and metadata entered or edited by a user can be classified as important, whereas metadata downloaded from the Internet can be classified as less important.

At step 310, the system can determine whether to overwrite the existing content item with the received content item based on the priority ordering of content. The system can compare the priorities assigned to the existing content item and the received content item and keep the content with the higher priority. For example, if the existing content item includes “system” metadata, the system can assign a high priority to the existing content item, and decide not to overwrite the existing content item with the received content item, in order to avoid overwriting system metadata. Here, the system can ignore the received content item and preserve the existing content item. In determining whether to overwrite the existing content item with the received content item, the system can decide to overwrite a portion of the existing content item and preserve another portion of the existing content item. For example, if the existing content item includes a song and metadata about the song, the system can overwrite the metadata with metadata from the received content item, but preserve the song from the existing content item. The system can also overwrite a portion of the metadata from the existing content item with metadata from the received content item, while also preserving a portion of the metadata from the existing content item and ignoring a portion of the metadata from the received content item.

Moreover, since the existing content item and the received content item can be duplicates even though they are not exactly the same, they can each contain content that is not included in the other. Here, the system can add content from the received content item that is not included in the existing content item, to supplement the existing content item with content from the received content item. For example, the existing content item can include a song and metadata for that song, while the received content item can include the same song and metadata for that song, including metadata not included in the existing content item. In this example, the metadata in the received content item that is not included in the existing content item can include, for example, the title of the song. Here, the system can add the title of the song from the metadata in the received content item to the metadata from the existing content item. This addition can be similarly based on the priority ordering. For example, the priority ordering can define a lower priority to null or empty values than data values. Thus, the title of the song from the metadata in the received content item can receive a higher priority than the corresponding empty value in the metadata from the existing content item. However, the priority ordering can also define a lower priority to data values associated with a specific source. Thus, in some cases, data values received from a specific source can be ignored based on a lower priority defined by the priority ordering.

Moreover, since the priority ordering can also define different priorities to different sources, the addition of metadata in this example can also depend on the priorities assigned to the source of the existing content item and the received content item. So, in some cases, the system can ignore a data value in the received content, such as the title of the song, even if the existing content item has a corresponding null or empty value, if the source of the received content item has a lower priority than the source of the existing content item. For example, if the source of the existing content item has a higher priority than the source of the received content item, the system can ignore the title of the song in the received content item even though the existing content item does not include a title of the song. Accordingly, the priority ordering can be based on multiple factors which, when calculated in the priority ordering, dictate whether content should be preserved, ignored, added, overwritten, etc.

In some embodiments, the priority ordering can be based on one or more rules implemented for selecting, ranking, ordering, ignoring, preserving, and/or overwriting metadata. The one or more rules can be based on various characteristics/attributes associated with the content, such as a content type, a source identity, a content quality, the content itself, a content property, an associated media item, an associated application, existing content, a flag, a configured parameter, etc. Here, the one or more rules can define how various characteristics/attributes of the content are ranked, weighed, calculated, related, compared, analyzed, interpreted, etc.

At step 312, if the system decides not to overwrite any portion of the existing content item with the received content item, the system can ignore the received content item. On the other hand, at step 314, if the system decides to overwrite any portion of the existing content item with the received content item, the system can overwrite some or all of the existing content item with some or all of the received content item. The system can then maintain the resulting content as a deduplicated content item and/or single instance of a content item. The deduplicated content item can include some or all of the received content and/or some or all of the existing content item. For example, if the system decides, based on the priority ordering, to simply ignore all of the received content and preserve the existing content item, the deduplicated content item can constitute the existing content item. Here, the priority ordering can protect and/or preserve content from different sources and/or content having certain attributes when maintaining and/or receiving content from different sources. Thus, users can share, synchronize, download, and/or retrieve content from different sources without losing or overwriting important content, and while also maintaining the identities of the different sources associated with the content.

In some embodiments, the priority ordering can define which properties should have existing content preserved when a lesser priority source tries to replace the existing content. In other embodiments, the priority ordering can define which properties do not apply to a given source. Here, any content with those properties that is for/from the given source can simply be ignored. For example, if a media item has existing content, such as a synchronization identifier stored in a database, and the system receives metadata associated with the media item from an online application which does not use or include a synchronization identifier, then the system can ignore the field in the database associated with the synchronization identifier, as there is no value from the online application metadata to override the existing synchronization identifier stored in the database. Yet in other embodiments, the priority ordering can define both the properties which should be preserved and the properties which should be ignored. For example, the priority ordering can be a matrix of source-to-rules for ignoring and preserving content.

FIG. 4 illustrates an example method embodiment. For the sake of clarity, the method is described in terms of an example system, such as system 650 shown in FIG. 6B below, configured to practice the method. The steps outlined herein are illustrative and can be implemented in any combination thereof, including combinations that exclude, add, or modify certain steps.

The system can analyze a first file from a first source to determine that the first file is a duplicate of a second file from a second source (400). The first file and the second file can include metadata and media content, such as video, audio, images, text, etc. The first file can be a file received by the system from the first source, and the second file can be a file stored at the system, for example. The system can compare the first file and the second file to identify the files as duplicates. The system can identify the files as duplicates by comparing identifiers associated with the files. For example, the system can analyze a synchronization identifier associated with the files to determine that the files are duplicates. The system can also compare the characteristics and/or attributes of the files to determine that the files are duplicates. Here, if the characteristics and/or attributes match and/or meet a similarity threshold, then the system can determine that the files are duplicates. The system can also use metadata associated with the files to determine that the files are duplicates. For example, if the files represent a song, the system can compare the name of the song, the title of the song, and/or the length of the song to determine if both files correspond to the same song, and are therefore duplicates.

Next, the system deduplicates the first file and the second file to yield a deduplicated file (402). The system can store the deduplicated file to maintain a single instance of the files. The system then selects metadata associated with at least one of the first file or the second file to be assigned as metadata for the deduplicated file, the metadata being selected based on a priority preference (404). When selecting metadata for the deduplicated file, the system can preserve a portion of the metadata from the first file and a portion of the metadata from the second file. Thus, the deduplicated file can include metadata from the first file and the second file. The system can also preserve all of the metadata from the first file and ignore some or all of the metadata from the second file, and vice versa. The system can also store the metadata selected to be assigned as metadata for the deduplicated file, and can associate the metadata with the deduplicated file. Further, the system can overwrite existing metadata stored in the database with the selected metadata.

The system can determine the identity of the first source and/or the second source. Moreover, the priority preference can be based on the identity of the first source and/or the second source. Here, different sources can be assigned different scores, weights, ranks, importance levels, etc. For example, the system can assign a higher ranking to one source, such as Apple® iTunes®, over another source, such as the Internet or Apple® iTunes® Match®. The identity of the source of the first file can thus be compared with the identity of the source of the second file to determine a priority based on the source identities. The priority preference can also be based on the type of metadata. For example, different types of metadata can be associated with different weights, scores, and/or degrees of importance. Thus, the metadata in a file can obtain a weight, score, and/or importance based on the type of metadata. To illustrate, metadata identified as “system” metadata can be classified as important, whereas synchronization metadata can be classified as less important. The priority preference can also be based on one or more rules implemented for selecting, ranking, ordering, ignoring, preserving, and/or overwriting metadata. The one or more rules can be based on various characteristics/attributes associated with the metadata, such as a metadata type, a metadata source, a metadata quality, a metadata value, a metadata property, an item associated with the metadata, an application associated with the metadata, a flag, a configured parameter, etc. Here, the one or more rules can define how various characteristics/attributes of the content are ranked, weighed, calculated, related, compared, analyzed, interpreted, etc. Thus, the one or more rules in the priority preference can be used to select the metadata for the deduplicated file.

FIG. 5 illustrates an example source-to-rules matrix 500 for managing metadata. The source-to-rules matrix 500 can include ranks 504 assigned to different sources 502 of data. The sources 502 can include any source of data, such as an online media store or a media application, for example. Each of the ranks 504 can be, for example, a score, weight, and/or priority assigned to a respective source from the sources 502. Moreover, each of the ranks 504 can be based on a respective trust associated with a source, an estimated quality or accuracy of data from the respective source, a user preference, a characteristic of a source, a type of data, an ordering of sources, a history, a data analysis, a parameter, a consistency, an amount of data from one or more sources 502, etc. The ranks 504 can be used to determine how to handle duplicate content items from one or more sources 502. For example, the ranks 504 can be used to determine which portions of metadata from two or more duplicate media items should be stored/preserved, and which portions should be ignored/removed. Here, the system can overwrite existing metadata from a lower ranked source with a duplicate of the metadata received from a higher ranked source. Also, the system can preserve existing metadata from a higher ranked source and ignore any duplicates of the metadata received from lower ranked sources.

The source-to-rules matrix 500 can also include rules for specific data 506 associated with the sources 502. The rules can define how to handle the specific data 506 from the corresponding sources 502. The rules can include rules for preserving, updating, and/or ignoring data associated with the sources 502. For example, the rules can specify that personalized data from the system, the user, or a synchronization should be preserved, while personalized data from the iTunes Store® or XYZ media service should be ignored. Here, a preserve rule can indicate that the existing data should be kept unless the new source of data is ranked higher according to the ranks 504, an update rule can indicate that existing data should be updated with the data from the new source, and an ignore rule can indicate that the existing data should not be updated with the data from the new source.

In some embodiments, the system can analyze duplicate items of data to identify the type of data of the duplicate items and the respective sources of data. Next, the system determines what preserve, update, and/or ignore rules apply based on the rules for the data types 506. The system then identifies a rank associated with the source of data from the ranks 504, and determines how to handle the duplicate items and/or the different portions of data associated with the duplicate items based on the ranks 504 and rules for the specific data types 506. The system can deduplicate the duplicate items, and preserve, ignore, and/or update any data associated with the duplicate items. The system can then store a single instance of the duplicate items, and any portions of data preserved and/or updated based on the ranks 504 and rules for the specific data types 506.

The example ranks, sources, and rules in FIG. 5 are provided for illustration purposes. As one of ordinary skill in the art will readily recognize, the source-to-rules matrix 500 can include different ranks, sources and/or rules than those illustrated in FIG. 5. As such, the number and/or type of ranks, sources and/or rules can vary.

FIG. 6A and FIG. 6B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 6A illustrates a conventional system bus computing system architecture 600 wherein the components of the system are in electrical communication with each other using a bus 605. Exemplary system 600 includes a processing unit (CPU or processor) 610 and a system bus 605 that couples various system components including the system memory 615, such as read only memory (ROM) 620 and random access memory (RAM) 625, to the processor 610. The system 600 can include a cache of high-speed memory connected directly with, in close proximity to, or integrated as part of the processor 610. The system 600 can copy data from the memory 615 and/or the storage device 630 to the cache 612 for quick access by the processor 610. In this way, the cache can provide a performance boost that avoids processor 610 delays while waiting for data. These and other modules can control or be configured to control the processor 610 to perform various actions. Other system memory 615 may be available for use as well. The memory 615 can include multiple different types of memory with different performance characteristics. The processor 610 can include any general purpose processor and a hardware module or software module, such as module 1 632, module 2 634, and module 3 636 stored in storage device 630, configured to control the processor 610 as well as a special-purpose processor where software instructions are incorporated into the actual processor design. The processor 610 may essentially be a completely self-contained computing system, containing multiple cores or processors, a bus, memory controller, cache, etc. A multi-core processor may be symmetric or asymmetric.

To enable user interaction with the computing device 600, an input device 645 can represent any number of input mechanisms, such as a microphone for speech, a touch-sensitive screen for gesture or graphical input, keyboard, mouse, motion input, speech and so forth. An output device 635 can also be one or more of a number of output mechanisms known to those of skill in the art. In some instances, multimodal systems can enable a user to provide multiple types of input to communicate with the computing device 600. The communications interface 640 can generally govern and manage the user input and system output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof.

The storage device 630 can include software modules 632, 634, 636 for controlling the processor 610. Other hardware or software modules are contemplated. The storage device 630 can be connected to the system bus 605. In one aspect, a hardware module that performs a particular function can include the software component stored in a computer-readable medium in connection with the necessary hardware components, such as the processor 610, bus 605, display 635, and so forth, to carry out the function.

FIG. 6B illustrates a computer system 650 having a chipset architecture that can be used in executing the described method and generating and displaying a graphical user interface (GUI). Computer system 650 is an example of computer hardware, software, and firmware that can be used to implement the disclosed technology. System 650 can include a processor 655, representative of any number of physically and/or logically distinct resources capable of executing software, firmware, and hardware configured to perform identified computations. Processor 655 can communicate with a chipset 660 that can control input to and output from processor 655. In this example, chipset 660 outputs information to output 665, such as a display, and can read and write information to storage device 670, which can include magnetic media, and solid state media, for example. Chipset 660 can also read data from and write data to RAM 675. A bridge 680 for interfacing with a variety of user interface components 685 can be provided for interfacing with chipset 660. Such user interface components 685 can include a keyboard, a microphone, touch detection and processing circuitry, a pointing device, such as a mouse, and so on. In general, inputs to system 650 can come from any of a variety of sources, machine generated and/or human generated.

Chipset 660 can also interface with one or more communication interfaces 690 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 655 analyzing data stored in storage 670 or 675. Further, the machine can receive inputs from a user via user interface components 685 and execute appropriate functions, such as browsing functions by interpreting these inputs using processor 655.

It can be appreciated that exemplary systems 600 and 650 can have more than one processor 610 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

We claim:

1. A method comprising:
analyzing a first file from a first source to determine that the first file is a duplicate of a second file from a second source;
deduplicating, via a processor, the first file and the second file to yield a deduplicated file; and
selecting metadata associated with at least one of the first file or the second file to be assigned as metadata for the deduplicated file, the metadata being selected based on a priority preference.

2. The method of claim 1, further comprising determining an identity of the first source, and wherein the priority preference is based on the identity of the first source.

3. The method of claim 2, wherein the priority preference is further based on a type of metadata.

4. The method of claim 1, further comprising storing, in a database, the metadata selected to be assigned as metadata for the deduplicated file, wherein the metadata is associated with the deduplicated file.

5. The method of claim 1, wherein the first file and the second file comprise media content and metadata.

6. The method of claim 1, further comprising overwriting existing metadata stored on a database with the metadata selected, wherein the existing metadata is associated with one of the first file or the second file.

7. The method of claim 1, wherein the priority preference comprises a matrix of rules that maps the first source and the second source to rules for ignoring or preserving files associated with the first source and the second source.

8. The method of claim 1, wherein the selected metadata overwrites a portion of existing metadata.

9. A method comprising:
receiving content at a device, the received content comprising a content item having content and at least a portion of metadata matching content and metadata associated with an existing content item stored at a content database, wherein the content database stores content items and respective metadata for each content item;
determining an identity of a source of the received content;
based on the identity of the source, determining a priority ordering of metadata associated with the content item and the existing content item;
deduplicating the content item and the existing content item based on the received content to yield a deduplicated content item, wherein the deduplicated content item is stored at the content database and associated with the respective metadata stored at the content database for the existing content item; and
based on the priority ordering of metadata, determining whether to overwrite any of the respective metadata associated with the deduplicated content item with any of the metadata associated with the content item.

10. The method of claim 9, wherein priorities assigned to metadata in the priority ordering of metadata vary based on a respective source of the metadata, and wherein portions of metadata associated with a given content item vary based on respective sources of the portions.

11. The method of claim 9, wherein deduplicating the content item and the existing content item, and determining whether to overwrite any of the respective metadata associated with the deduplicated content item with any of the metadata associated with the content item are further based on the identity of the source.

12. The method of claim 9, wherein at least one of determining a priority ordering of metadata or determining whether to overwrite any of the respective metadata associated with the deduplicated content item with any of the metadata associated with the content item is further based on a matrix of rules that maps a source to rules for ignoring or preserving metadata values received from the source that correspond to metadata fields in the content database.

13. A system comprising:
a processor; and
a computer-readable medium having stored thereon instructions which, when executed by the processor, cause the processor to perform operations comprising:
analyzing a first file from a first source to determine that the first file is a duplicate of a second file from a second source;
deduplicating the first file and the second file to yield a deduplicated file; and
selecting metadata associated with at least one of the first file or the second file to be assigned as metadata for the deduplicated file, the metadata being selected based on a priority preference.

14. The system of claim 13, wherein the computer-readable storage medium stores additional instructions which result in the operations further comprising determining an identity of the first source, and wherein the priority preference is based on the identity of the first source.

15. The system of claim 13, wherein the computer-readable storage medium stores additional instructions which result in the operations further comprising storing, in a database, the metadata selected to be assigned as metadata for the deduplicated file, wherein the metadata is associated with the deduplicated file.

16. The system of claim 13, wherein the priority preference comprises a matrix of rules that maps the first source and the second source to rules for ignoring or preserving files associated with the first source and the second source.

17. A non-transitory computer-readable storage medium having stored therein instructions which, when executed by a processor, cause the processor to perform operations comprising:
analyzing a first file from a first source to determine that the first file is a duplicate of a second file from a second source;
deduplicating the first file and the second file to yield a deduplicated file; and
selecting metadata associated with at least one of the first file or the second file to be assigned as metadata for the deduplicated file, the metadata being selected based on a priority preference.

18. The non-transitory computer-readable storage medium of claim 17, storing additional instructions which result in the operations further comprising determining an identity of the first source, and wherein the priority preference is based on the identity of the first source.

19. The non-transitory computer-readable storage medium of claim 17, storing additional instructions which result in the operations further comprising storing, in a database, the metadata selected to be assigned as metadata for the deduplicated file, wherein the metadata is associated with the deduplicated file.

20. The non-transitory computer-readable storage medium of claim 17, wherein the priority preference comprises a matrix of rules that maps the first source and the second source to rules for ignoring or preserving files associated with the first source and the second source.
